(19) United States
(12) Patent Application Publication
(10) Pub. No.: US 2016/0125429 A1
(43) Pub. Date: May 5, 2016

(54) SYSTEM AND METHOD FOR GENERATING MOTIVATON PROFILES OF INDIVIDUALS

(71) Applicant: Cognizant Technology Solutions India Pvt. Ltd., Chennai, TN (US)

(72) Inventor: Andy FANNING, Lake Ozark, MO (US)

(21) Appl. No.: 14/599,646

(22) Filed: Jan. 19, 2015

(30) Foreign Application Priority Data
Oct. 31, 2014 (IN) 5465/CHE/2014

(51) Int. Cl. G06Q 30/02

(52) U.S. Cl. CPC G06Q 30/0201

(57) ABSTRACT

A system and computer-implemented method for generating motivation profiles of one or more individuals is provided. The system comprises an administrator interface configured to provide options for configuring default profiles and defining one or more stimuli. The system further comprises a processing module configured to present the one or more defined stimuli to the one or more individuals. The processing module is further configured to receive and process responses to the one or more presented stimuli. Also, the processing module determines if one or more motivational factors associated with the one or more presented stimuli influenced the behavior of the one or more individuals. The processing module further determines degree of influence of each of one or more motivational factors on the one or more individuals. In addition, the processing module is configured to generate motivation profiles of the individuals based on the determined degree of influence.

### CROSS REFERENCE TO RELATED APPLICATION

This application is related to and claims the benefit of Indian Patent Application No. 5465/CHE/2014 filed on Oct. 31, 2014, the contents of which are herein incorporated by reference in their entirety.

### FIELD OF THE INVENTION

The present invention relates generally to generating motivation profiles. More particularly, the present invention provides a system and method for generating motivation profiles of one or more individuals to determine one or more factors that motivate and influence behavior of the one or more individuals.

### BACKGROUND OF THE INVENTION

Understanding human behavior and psychology is of paramount importance for organizations especially in retail and healthcare sectors. As different people are motivated by different reasons, understanding human behavior helps organizations in determining factors that motivate individuals. For example, retail organizations need to know what motivates customers to make a purchase, what motivates their employees to perform better and so on. Some individuals are motivated and influenced by challenges and competitive environment as against others who might be more inclined towards teamwork or attaining a social standing.

Conventionally, various systems and methods exist for determining factors that motivate individuals. For example, gamification techniques are used to determine user engagement and motivation. Organizations use these techniques for marketing to attract customers and employee retention. However, the gamification techniques test an individual or group of individuals on a single motivation factor. The above-mentioned gamification techniques do not determine various motivation factors that influence behavior. Moreover, motivation factors for individuals may change over time. The above-mentioned gamification techniques often do not take into account such changes.

In light of the above, there is a need for a system and method to accurately determine one or more factors that motivate and influence behavior of one or more individuals. Further, there is a need for a system and method for generating motivation profiles of the one or more individuals. Furthermore, there is a need for a system and method that is capable of modifying the motivation profiles of the individuals based on a change in the motivation factors that influence behavior of the one or more individuals.

### SUMMARY OF THE INVENTION

A system and computer-implemented method for generating motivation profiles of one or more individuals is provided. The system comprises an administrator interface configured to provide one or more options to one or more administrators to configure one or more default profiles, wherein configuring the one or more default profiles comprises assigning an initial value to each of one or more motivational factors listed in the one or more default profiles; and define one or more stimuli, wherein defining the one or more stimuli comprises associating the one or more stimuli with the one or more motivational factors. The system further comprises a processing module configured to present one or more defined stimuli to the one or more individuals on one or more user devices. The processing module is further configured to receive one or more responses to the one or more presented stimuli from the one or more individuals. Furthermore, the processing module is configured to process the one or more received responses. Also, the processing module is configured to determine, using the one or more processed responses, if the one or more motivational factors associated with the one or more presented stimuli influenced the behavior of the one or more individuals and motivated the one or more individuals to perform one or more actions corresponding to the one or more presented stimuli. The processing module is further configured to determine, using the one or more processed responses, degree of influence of each of the one or more motivational factors associated with the one or more presented stimuli on the one or more individuals. In addition, the processing module is configured to generate motivation profiles of the one or more individuals by modifying the initial value assigned to each of the one or more motivational factors, listed in the one or more configured default profiles, based on the determined degree of influence of each of the one or more motivational factors on the one or more individuals.

In an embodiment of the present invention, the administrator interface further provides one or more options to the one or more administrators to define one or more feedbacks and associate the one or more defined feedbacks with the one or more defined stimuli and the one or more motivational factors.

In an embodiment of the present invention, the processing module is further configured to present the one or more defined feedbacks to the one or more individuals via the one or more user devices based on the one or more received responses. The processing module is further configured to receive one or more additional responses to the one or more presented feedbacks from the one or more individuals. Furthermore, the processing module is configured to process the one or more additional responses. The processing module is also configured to determine, using the one or more processed additional responses, if the one or more motivational factors associated with the one or more presented feedbacks influenced the behavior of the one or more individuals and motivated the one or more individuals to further perform the one or more actions corresponding to the one or more presented stimuli. The processing module is further configured to determine, using the one or more processed additional responses, degree of influence of each of the one or more motivational factors associated with the one or more presented feedbacks on the one or more individuals. In addition, the processing module is configured to modify the generated motivation profiles of the one or more individuals by updating the modified value of each of the one or more motivational factors, listed in the one or more generated motivation profiles, based on the determined degree of influence of each of the one or more motivational factors associated with the one or more presented feedbacks on the one or more individuals.

In an embodiment of the present invention, the processing module is configured to present one or more additional stimuli to the one or more individuals based on the modified motivation profiles of the one or more individuals, wherein the one or more additional stimuli are associated with additional motivational factors. The processing module is further configured to process one or more responses to the one or more additional stimuli. Furthermore, the processing module is configured to update the modified motivation profiles of the one or more individuals by updating values of the additional motivational factors, listed in the one or more generated motivation profiles, based on the processed one or more responses to the one or more additional stimuli.

In an embodiment of the present invention, the initial value assigned to the one or more motivational factors listed in the one or more default profiles is a percentage and further wherein sum total of values of all motivational factors listed in the one or more default profiles is one hundred percent (100%). In an embodiment of the present invention, the one or more motivational factors include at least one of: competition, challenge, personal progression, social status, money, autonomy, exploration, social responsibility, charity, and affection. In an embodiment of the present invention, defining the one or more stimuli comprises assigning a value to each of the one or more motivational factors associated with the one or more stimuli. In an embodiment of the present invention, the one or more user devices include at least one of: tablets, smartphones, laptops, gaming devices and any other electronic devices. In an embodiment of the present invention, the processing module is configured to: present one or more additional stimuli to the one or more individuals based on the generated motivation profiles of the one or more individuals, wherein the one or more additional stimuli are associated with additional motivational factors. The processing module is further configured to process one or more responses to the one or more additional stimuli. Furthermore, the processing module is configured to modify the generated motivation profiles of the one or more individuals by modifying value of the additional motivational factors, listed in the one or more generated motivation profiles, based on the processed one or more responses to the one or more additional stimuli. In an embodiment of the present invention, the one or more administrators include at least one of: Human Resource (HR) managers, resource planners, senior managers, senior executives and stakeholders of an organization.

The computer-implemented method for generating motivation profiles of one or more individuals, via program instructions stored in a memory and executed by a processor, comprises configuring one or more default profiles, wherein configuring the one or more default profiles comprises assigning an initial value to each of one or more motivational factors listed in the one or more default profiles. The computer-implemented method further comprises defining one or more stimuli, wherein defining the one or more stimuli comprises associating the one or more stimuli with the one or more motivational factors. Furthermore, the computer-implemented method comprises presenting the one or more defined stimuli to the one or more individuals on one or more user devices. Also, the computer-implemented method comprises receiving one or more responses to the one or more presented stimuli from the one or more individuals and processing the one or more received responses. The computer-implemented method further comprises determining, using the one or more processed responses, if the one or more motivational factors associated with the one or more presented stimuli influenced the behavior of the one or more individuals and motivated the one or more individuals to perform one or more actions corresponding to the one or more presented stimuli. In addition, the computer-implemented method comprises determining, using the one or more processed responses, degree of influence of each of the one or more motivational factors associated with the one or more presented stimuli on the one or more individuals. The computer-implemented method also comprises generating motivation profiles of the one or more individuals by modifying the initial value assigned to each of the one or more motivational factors, listed in the one or more configured default profiles, based on the determined degree of influence of each of the one or more motivational factors on the one or more individuals.

In an embodiment of the present invention, the computer-implemented method further comprises defining one or more feedbacks and associating the one or more defined feedbacks with the one or more defined stimuli and the one or more motivational factors.

In an embodiment of the present invention, the computer-implemented method further comprises presenting the one or more defined feedbacks to the one or more individuals via the one or more user devices based on the one or more received responses. Furthermore, the computer-implemented method comprises receiving one or more additional responses to the one or more presented feedbacks from the one or more individuals. Also, the computer-implemented method comprises processing the one or more additional responses. The computer-implemented method further comprises determining, using the one or more processed additional responses, if the one or more motivational factors associated with the one or more presented feedbacks influenced the behavior of the one or more individuals and motivated the one or more individuals to further perform the one or more actions corresponding to the one or more presented stimuli. Furthermore, the computer-implemented method further comprises determining, using the one or more processed additional responses, degree of influence of each of the one or more motivational factors associated with the one or more presented feedbacks on the one or more individuals. In addition, the computer-implemented method comprises modifying the generated motivation profiles of the one or more individuals by updating the modified value of each of the one or more motivational factors, listed in the one or more generated motivation profiles, based on the determined degree of influence of each of the one or more motivational factors associated with the one or more presented feedbacks on the one or more individuals.

In an embodiment of the present invention, the computer-implemented method further comprises presenting one or more additional stimuli to the one or more individuals based on the modified motivation profiles of the one or more individuals, wherein the one or more additional stimuli are associated with additional motivational factors. Furthermore, the computer-implemented method comprises processing one or more responses to the one or more additional stimuli. Also, In an embodiment of the present invention, the computer-implemented method further comprise updating the modified motivation profiles of the one or more individuals by updating values of the additional motivational factors, listed in the one or more generated motivation profiles, based on the processed one or more responses to the one or more additional stimuli.

In an embodiment of the present invention, the computer-implemented method further comprises presenting one or more additional stimuli to the one or more individuals based on the generated motivation profiles of the one or more individuals, wherein the one or more additional stimuli are associated with additional motivational factors. Furthermore, the computer-implemented method comprises processing one or more responses to the one or more additional stimuli. Also, the computer-implemented method comprises modifying the generated motivation profiles of the one or more individuals by modifying value of the additional motivational factors, listed in the one or more generated motivation profiles, based on the processed one or more responses to the one or more additional stimuli.

A computer program product for generating motivation profiles of one or more individuals is provided. The computer program product comprising: a non-transitory computer-readable medium having computer-readable program code stored thereon, the computer-readable program code comprising instructions that when executed by a processor, cause the processor to configure one or more default profiles, wherein configuring the one or more default profiles comprises assigning an initial value to each of one or more motivational factors listed in the one or more default profiles. The processor further defines one or more stimuli, wherein defining the one or more stimuli comprises associating the one or more stimuli with the one or more motivational factors. Furthermore, the processor presents the one or more defined stimuli to the one or more individuals on one or more user devices. Also, the processor receive one or more responses to the one or more presented stimuli from the one or more individuals. In addition, the processor processes the one or more received responses and determines, using the one or more processed responses, if the one or more motivational factors associated with the one or more presented stimuli influenced the behavior of the one or more individuals and motivated the one or more individuals to perform one or more actions corresponding to the one or more presented stimuli. The processor further determines, using the one or more processed responses, degree of influence of each of the one or more motivational factors associated with the one or more presented stimuli on the one or more individuals. The processor also generates motivation profiles of the one or more individuals by modifying the initial value assigned to each of the one or more motivational factors, listed in the one or more configured default profiles, based on the determined degree of influence of each of the one or more motivational factors on the one or more individuals.

### BRIEF DESCRIPTION OF THE ACCOMPANYING DRAWINGS

The present invention is described by way of embodiments illustrated in the accompanying drawings wherein:

FIG. 1 is a block diagram illustrating a system for generating motivation profiles of one or more individuals, in accordance with an embodiment of the present invention;

FIGS. 2A, 2B and 2C represent a flowchart illustrating a method for generating motivation profiles of one or more individuals, in accordance with an embodiment of the present invention; and

FIG. 3 illustrates an exemplary computer system for generating motivation profiles of one or more individuals, in accordance with an embodiment of the present invention.

### DETAILED DESCRIPTION OF THE INVENTION

A system and method for generating motivation profiles of one or more individuals to determine one or more factors that motivate and influence behavior of one or more individuals is described herein. Further, the invention provides for a system and method that is capable of modifying the motivation profiles of the individuals based on a change in the motivational factors that influence behavior of the one or more individuals.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

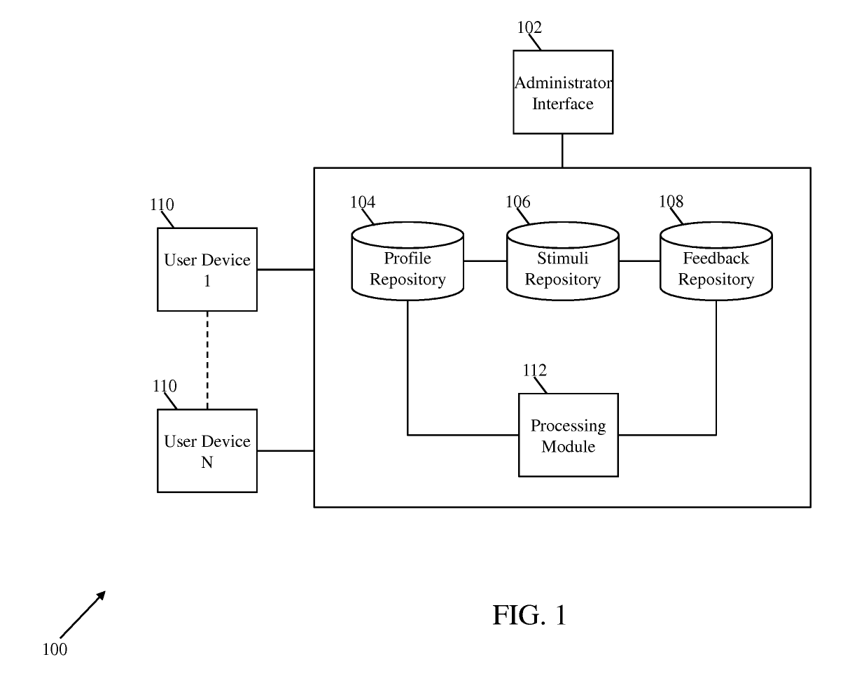

FIG. 1 is a block diagram illustrating a system for generating motivation profiles of one or more individuals, in accordance with an embodiment of the present invention. The system 100 comprises an administrator interface 102, a profile repository 104, a stimuli repository 106, a feedback repository 108, one or more user devices 110 and a processing module 112.

The administrator interface 102 is a front-end interface configured to provide options to one or more administrators to configure one or more default profiles which are used for generating motivation profiles of one or more individuals. In an embodiment of the present invention, the one or more administrators include, but not limited to, Human Resource (HR) managers, resource planners, senior managers, senior executives and stakeholders of an organization. In an embodiment of the present invention, the one or more individuals include, but not limited to, employees, customers, patients, students and sportspersons. Each of the one or more default profiles are configured using a pre-stored template accessed via the administrator interface 102. The pre-stored template comprise one or more motivational factors such as, but not limited to, competition, challenge, personal progression, money, autonomy, exploration, social responsibility, social status, charity, and affection that are considered to motivate individuals and influence human behavior. In an embodiment of the present invention, the pre-stored template may have a dropdown list from which the one or more motivational factors are selected by the one or more administrators. The one or more administrators then assigns an initial value to each of the one or more selected motivational factors for configuring the one or more default profiles. In another embodiment of the present invention, the one or more administrators provide information pertaining to the one or more individuals based on which a default profile is automatically configured using the pre-stored template. In an embodiment of the present invention, the information pertaining to the one or more individuals include, but not limited to, employee name, age, date of joining, role and designation, customer details and purchase history. The configured default profile has all the motivational factors pre-listed along with an initial value assigned to each of the one or more pre-listed motivational factors. In an embodiment of the present invention, the initial value assigned to the one or more motivational factors listed in the one or more default profiles is a percentage. Further, the sum total of all the percentages is 100% for each of the one or more default profiles with a minimum of 1% being assigned to each motivational factor. For example, a default profile is configured using the following four motivational factors with equal initial percentage values as:

Social status—25%
Personal progression—25%

### Money—25%

### Charity—25%

In an embodiment of the present invention, the one or more configured default profiles are stored in the profile repository 104.

The administrator interface 102 also facilitates the one or more administrators to define one or more stimuli. Each of the one or more stimuli is associated with the one or more motivational factors which may influence behavior of the one or more individuals and prompt the one or more individuals to perform one or more actions related to the one or more stimuli. The one or more administrators also assign values to each of the motivational factors associated with the one or more stimuli via the administrator interface 102. In an embodiment of the present invention, the values assigned to each of the motivational factors associated with the one or more stimuli are percentages. The values assigned to the motivational factors associated with the one or more stimuli represent the contribution of that motivational factor in influencing the behavior of the one or more individuals as compared with other motivational factors associated with the one or more stimuli. The assigned values are used for generating the motivation profiles of the one or more individuals. In an embodiment of the present invention, the values to be assigned to each of the one or more motivational factors associated with the one or more stimuli are decided by the management of the organization. In an embodiment of the present invention, the one or more defined stimuli are stored in the stimuli repository 106.

In an exemplary embodiment of the present invention, a stimulus is in the form of a text message such as, but not limited to, “10 more sales today and you will beat your all time high” which is presented to a sales person on his handheld device. The motivational factor associated with this stimulus is “personal progression”. The percentage assigned to the motivational factor “personal progression” is 100% as there are no other associated motivational factors. In another exemplary embodiment of the present invention, the stimulus is in the form of a text message such as, but not limited to, “you have earned the master salesman status and can now give tips to your juniors”. The second exemplary stimulus has two motivational factors (“social status” and “social responsibility”) associated with it that may influence the sales person. The percentage values assigned to the motivational factors “social status” and “social responsibility” are 70% and 30% respectively.

The one or more administrators also define one or more feedbacks and associate the one or more feedbacks with the one or more stimuli. In an embodiment of the present invention, the one or more feedbacks are in the form of, but not limited to, leaderboards, progress indicators and text messages. The one or more feedbacks are presented to the one or more individuals when the one or more actions are taken by the one or more individuals based on the presented one or more stimuli. Further, each of the one or more feedbacks is associated with the one or more motivational factors. The one or more administrators assign values to each of the motivational factors associated with the one or more feedbacks via the administrator interface 102. The assigned values are used for generating the motivation profiles of the one or more individuals. In an embodiment of the present invention, the values to be assigned to each of the one or more motivational factors associated with the one or more feedbacks are decided by the management of the organization. In an embodiment of the present invention, the one or more defined feedbacks are stored in the feedback repository 108. In an embodiment of the present invention, the one or more default profiles, the one or more defined stimuli and the one or more defined feedbacks are stored in a single repository.

The one or more user devices 110 are electronic devices used by the one or more individuals whose motivation profiles are to be generated. In an embodiment of the present invention, the one or more user devices 110 include, but not limited to, tablets, smartphones, laptops, gaming devices and any other electronic devices.

The processing module 112 is configured to present the one or more defined stimuli, stored in the stimuli repository 106, on the one or more user devices 110. In an embodiment of the present invention, the one or more stimuli are presented to the one or more individuals based on the designation and role of that particular individual in the organization.

In an embodiment of the present invention, the one or more user devices 110 comprise an application for presenting the one or more stimuli on the one or more user devices 110. Further, the one or more administrators define one or more areas within the application where the one or more stimuli are presented. In an embodiment of the present invention, the application is pre-installed on the one or more user devices 110 and the one or more stimuli are automatically presented by the processing module 112. In yet another embodiment of the present invention, the application is hosted in a cloud computing environment and accessed via the one or more user devices 110. In yet another embodiment of the present invention, the application is a web-based application.

Once the one or more stimuli are presented to the one or more individuals, the processing module 112 receives one or more responses from the one or more individuals. The one or more responses are the one or more actions, associated with the presented one or more stimuli, performed by the one or more individuals. Referring back to the exemplary embodiment mentioned in the earlier sections of the specification, on being presented the stimulus such as “10 more sales today and you will beat your all time high”, the sales person may be influenced and thereby ensure 10 sales in order to achieve an all time high record. In this particular example, the action comprises ensuring 10 sales which is associated with the presented stimulus. Alternately, the sales person may not achieve the target of 10 sales or may not perform any action in response to the presented stimulus.

The processing module 112 processes the one or more responses received from the one or more individuals. The processing module 112 then determines, using the one or more processed responses, if the one or more motivational factors associated with the one or more presented stimuli influenced the behavior of the one or more individuals and motivated the one or more individuals to perform one or more actions corresponding to the one or more presented stimuli. The processing module 112 also determines degree of influence of each of the one or more motivational factors associated with the one or more presented stimuli on the one or more individuals. During operation, a positive response to the one or more presented stimuli facilitates the processing module 112 in determining that the motivational factors associated with the one or more presented stimuli resulted in behavior change. In another embodiment of the present invention, if an individual does not respond to the stimulus, then the processing module 112 determines that the motivational factors associated with the presented stimulus do not influence behavior of the individual and therefore did not elicit any response from the one or more individuals.

The processing module 112 then generates the motivation profiles of the one or more individuals by modifying the initial value assigned to each of the one or more motivational factors listed in the one or more configured default profiles. Further, the initial value is modified based on the degree of influence of each of the one or more motivational factors on the one or more individuals.

Referring back to the exemplary embodiment mentioned in the earlier sections of the specification, if the sales person is influenced by the stimulus “10 more sales today and you will beat your all time high” and ensures 10 sales then the value assigned to the motivational factor “personal progression” is increased and the values assigned to other motivational factors are decreased. For example, the modified values of the motivational factors may be as follows:

Social status—20%
Personal progression—60%

### Money—19%

### Charity—1%

Simultaneously, the processing module 112 presents the one or more defined feedbacks to the one or more individuals based on the received one or more responses to the one or more presented stimuli. The processing module 112 then receives one or more additional responses to the one or more presented feedbacks from the one or more individuals and processes them. Further, the processing module 112 determines, using the one or more processed additional responses, if the one or more motivational factors associated with the one or more presented feedbacks influenced the behavior of the one or more individuals and motivated the one or more individuals to further perform the one or more actions corresponding to the one or more presented stimuli. The processing module 112 also determines, using the one or more processed additional responses, degree of influence of each of the one or more motivational factors associated with the one or more presented feedbacks on the one or more individuals. The processing module 112 then modifies the generated motivation profiles of the one or more individuals by updating the modified value of the one or more motivational factors listed in the one or more generated motivation profiles. The modified value of the one or more motivational factors are updated based on the determined degree of influence of each of the one or more motivational factors associated with the one or more presented feedbacks on the one or more individuals.

Referring back to the exemplary embodiment mentioned in the earlier sections of the specification, the processing module 112 keeps a track of the number of sales achieved by the sales person after being presented with the stimulus “10 more sales today and you will beat your all time high”. The processing module 112 then presents the feedback in the form of a “sales indicator” to the sales person via his handheld device. The processing module 112 continuously presents the number of sales via the “sales indicator” to the sales person. The processing module 112 then determines percentage change in the number of sales after presenting the stimulus and the feedback. The determined percentage change in the number of sales facilitates the processing module 112 in modifying the value of the one or more motivational factors to represent the degree of influence of each of the one or more motivational factors listed in the motivation profile of the sales person.

Once the motivation profiles of the one or more individuals are generated, the processing module 112 present additional stimuli and feedbacks associated with other motivational factors to the one or more individuals. In an embodiment of the present invention, the additional stimuli are presented to the one or more individuals based on the generated motivation profiles of the one or more individuals and previously presented one or more stimuli and feedbacks. The processing module 112 then processes the one or more responses, received from the one or more individuals, to determine if the behavior of the one or more individuals is influenced by the motivational factors associated with the additional stimuli presented to the one or more individuals. The processing module 112 thereby accurately determines all the motivational factors that influence the behavior of the one or more individuals and updates the one or more generated motivation profiles of the one or more individuals. Further, the processing module 112 calculates the value to be assigned to each of the one or more motivational factors based on the behavior change facilitated by additional stimuli and feedback presented to the one or more individuals.

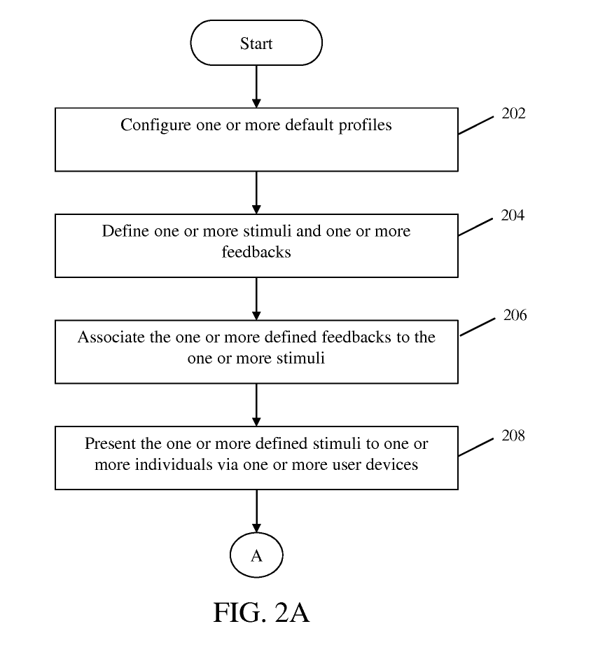

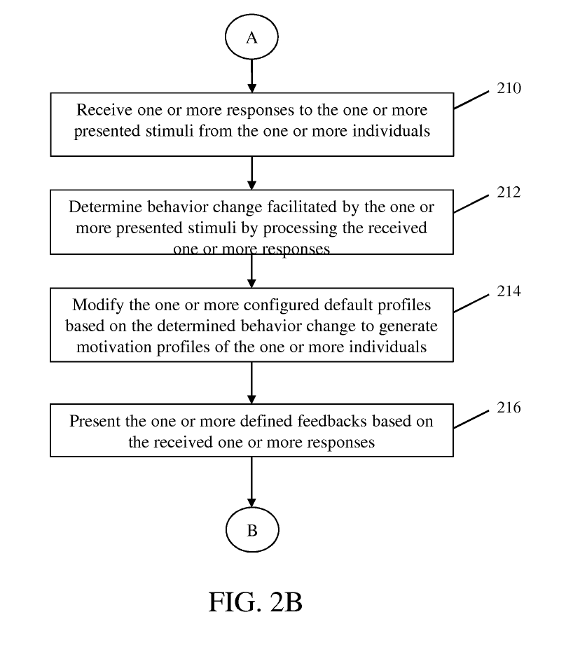

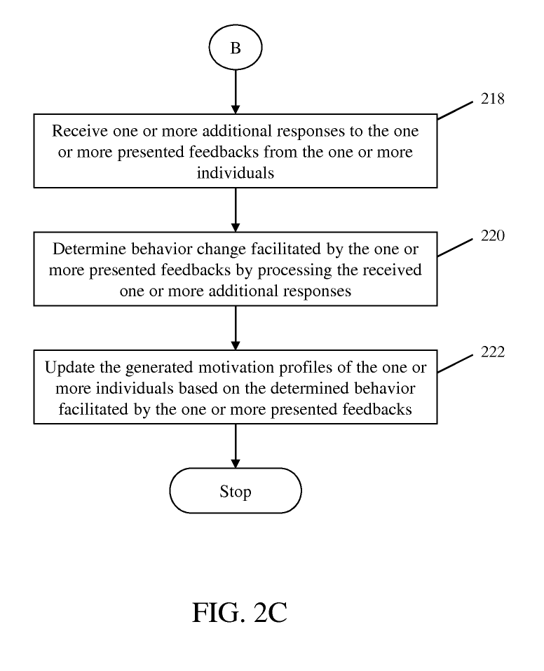

FIGS. 2A, 2B and 2C represent a flowchart illustrating a method for generating motivation profiles of one or more individuals, in accordance with an embodiment of the present invention.

At step 202, one or more default profiles are configured by one or more administrators. The one or more default profiles are configured using a pre-stored template that may be accessed via an administrator interface by the one or more administrators. In an embodiment of the present invention, the one or more administrators include, but not limited to, Human Resource (HR) managers, resource planners, senior managers, senior executives and stakeholders of an organization. The pre-stored template comprise one or more motivational factors such as, but not limited to, competition, challenge, personal progression, social status, money, autonomy, exploration, social responsibility, charity, and affection that are considered to motivate individuals and influence human behavior. In an embodiment of the present invention, the pre-stored template may have a dropdown list from which the one or more motivational factors are selected by the one or more administrators. The one or more administrators then assigns an initial value to each of the one or more selected motivational factors for configuring the one or more default profiles. In another embodiment of the present invention, the one or more administrators provide information pertaining to the one or more individuals based on which a default profile is automatically configured by modifying the pre-stored template. In an embodiment of the present invention, the information pertaining to the one or more individuals include, but not limited to, employee name, age, date of joining, role and designation, customer details and purchase history. The automatically configured default profile has all the motivational factors pre-listed along with an initial value assigned to each of the one or more pre-listed motivational factors. In an embodiment of the present invention, the initial value assigned to the one or more motivational factors listed in the one or more default profiles is a percentage. Further, the sum total of all the initial percentage values is one hundred percent (100%) for each of the one or more default profiles with a minimum of one percent (1%) assigned to each motivational factor. The one or more configured default profiles are stored and modified for generating motivation profiles of one or more individuals. In an embodiment of the present invention, the one or more individuals include, but not limited to, employees, customers, patients, students and sportspersons.

At step 204, the one or more administrators define one or more stimuli and one or more feedbacks to be presented to the one or more individuals. Each of the one or more stimuli is associated with the one or more motivational factors which may influence behavior of the one or more individuals. Once this association is set, the one or more stimuli are known as one or more defined stimuli. The one or more defined stimuli are used to prompt the one or more individuals to perform one or more actions related to the one or more defined stimuli. In an exemplary embodiment of the present invention, a stimulus, defined by the one or more administrator for a sales person of an organization, is in the form of a text message “10 more sales today and you will beat your all time high” which is presented to the sales person on his handheld device. The motivational factor associated with this stimulus is “personal progression”. In another exemplary embodiment of the present invention, the stimulus is in the form of a text message “you have earned the master salesman status and can now give tips to your juniors”. The second exemplary stimulus has two motivational factors (“social status” and “social responsibility”) associated with it that may influence the sales person. The one or more administrators also assign percentages to each of the motivational factors associated with the one or more defined stimuli. The assigned percentages are used for generating the motivation profiles of the one or more individuals. In an embodiment of the present invention, the percentages are decided by the management of the organization.

The one or more administrators also define one or more feedbacks. In an embodiment of the present invention, the one or more feedbacks are in the form of, but not limited to, leaderboards, progress indicators and text messages. The one or more feedbacks are presented to the one or more individuals when the one or more actions are taken by the one or more individuals based on the presented one or more stimuli. Further, each of the one or more feedbacks is associated with the one or more motivational factors. The one or more administrators assign values to each of the motivational factors associated with the one or more feedbacks. The assigned values are used for generating the motivation profiles of the one or more individuals. In an embodiment of the present invention, the values to be assigned to each of the one or more motivational factors associated with the one or more feedbacks are decided by the management of the organization. In an embodiment of the present invention, the one or more defined feedbacks are stored in a feedback repository. In an embodiment of the present invention, the one or more defined profiles, the one or more defined stimuli and the one or more defined feedbacks are stored in a single repository.

At step 206, the one or more defined feedbacks are associated with the one or more defined stimuli. The one or more associated feedbacks are presented to the one or more individuals when the one or more individuals perform one or more actions corresponding to the one or more defined stimuli.

At step 208, the one or more defined stimuli are presented to the one or more individuals via one or more user devices. The one or more user devices are electronic devices used by the one or more individuals whose motivation profiles are to be generated. In an embodiment of the present invention, the one or more user devices include, but not limited to, tablets, smartphones, laptops, gaming devices and any other electronic devices. In an exemplary embodiment of the present invention, the one or more stimuli are presented to an employee of an organization based on his designation and role in the organization.

In an embodiment of the present invention, the one or more individuals access an application on the one or more user devices. The application is configured to present the one or more defined stimuli on the one or more user devices. Further, the one or more administrators define one or more areas within the application where the one or more stimuli are to be presented. In another embodiment of the present invention, the application is pre-installed on the one or more user devices and the one or more stimuli are automatically presented on the one or more user devices by the application. In yet another embodiment of the present invention, the application is hosted in a cloud computing environment and accessed via the one or more user devices. In yet another embodiment of the present invention, the application is a web-based application.

At step 210, one or more responses to the one or more presented stimuli are received from the one or more individuals. Further, the one or more responses are the one or more actions, associated with the presented one or more stimuli, that are performed by the one or more individuals. In an embodiment of the present invention, the one or more responses are received by a processing module via the one or more user devices. Referring back to the exemplary embodiment mentioned in the earlier sections of the specification, on being presented the stimulus such as “10 more sales today and you will beat your all time high”, the sales person may be influenced and thereby perform 10 sales in order to achieve an all time high record. In this particular example, the action comprises performing 10 sales which is associated with the presented stimulus. Alternately, the sales person may not achieve the target of 10 sales or may not perform any action in response to the presented stimulus. The sales person's response to the presented stimulus is received by a processing module for further processing and determining behavior change.

At step 212, behavior change facilitated by the one or more presented stimuli is determined by processing the one or more received responses. Further, determining behavior change comprises determining if the one or more motivational factors associated with the one or more presented stimuli influenced the behavior of the one or more individuals and motivated the one or more individuals to perform the one or more actions corresponding to the one or more presented stimuli. Also, determining behavior change comprises determining degree of influence of each of the one or more motivational factors associated with the one or more presented stimuli on the one or more individuals.

In an embodiment of the present invention, a positive response to the one or more presented stimuli facilitates the processing module in determining that the one or more motivational factors associated with the one or more presented stimuli resulted in behavior change. Referring back to the example mentioned above, if the sales person exceeds the number of sales (i.e. 10) mentioned in the stimulus (“10 more sales today to beat your all time high”) presented to him, then the processing module determines that the presented stimulus and its associated motivational factor (i.e. personal progression) motivated the sales person and influenced him to achieve the required number of sales to beat his own record. In another embodiment of the present invention, a cashier scans 10 items per minute while billing at a supermarket. On being presented a stimulus, the cashier is influenced and speed of service increases to 15 items per minute. The processing module thereby determines that the cashier is influenced by the one or more motivational factors associated with the presented stimulus and the percentage change in the number of items scanned per minute represents the degree of influence of the one or more motivational factors on the cashier. In yet another embodiment of the present invention, if an individual does not respond to the stimulus, then the processing module determines that the motivational factors associated with the presented stimulus do not influence the individual and further determines that the degree of influence is nil.

At step 214, motivation profiles of the one or more individuals are generated by modifying the initial value assigned to each of the one or more motivational factors listed in the one or more configured default profiles. The initial value assigned to each of the one or more motivational factors is modified based on the determined degree of influence of each of the one or more motivational factors on the one or more individuals. In an embodiment of the present invention, the percentage assigned to each of the one or more motivational factors that influence the individual's behavior are modified. If the one or more individuals are motivated by a particular motivational factor that resulted in behavior change then the percentage assigned to that motivational factor is increased as compared to other motivational factors. Referring back to the example mentioned in earlier paragraphs of the specification, the processing module increases the percentage assigned to the motivational factor “personal progression” to generate a motivation profile pertaining to the sales person. The percentage assigned to other motivational factors listed in the generated motivation profile is decreased so that the sum total of percentages of all motivational factors is one hundred percent (100%).

At step 216, the one or more defined feedbacks associated with the one or more presented stimuli are presented to the one or more individuals. The one or more defined feedbacks are presented based on the received one or more responses. Referring back to the example mentioned above, the feedback presented to a sales person may be in the form of a text message such as, but not limited to, “Great Job! You beat your personal best” if the sales person exceeds the number of sales (i.e. 10) mentioned in the stimulus (“10 more sales today to beat your all time high”). If the sales person did not achieve the number of sales mentioned in the stimulus, then a feedback in the form of a text message such as, but not limited to, “Only 2 more sales needed to beat your own record” is presented to the sales person on his handheld device.

At step 218, one or more additional responses to the one or more presented feedbacks are received from the one or more individuals.

At step 220, behavior change facilitated by the one or more presented feedbacks is determined by processing the received one or more additional responses and using the one or more processed additional responses. Further, determining behavior change facilitated by the one or more presented feedbacks comprises determining if the one or more motivational factors associated with the one or more presented feedbacks influenced the behavior of the one or more individuals and motivated the one or more individuals to further perform the one or more actions corresponding to the one or more presented stimuli. Also, determining behavior change comprises determining degree of influence of each of the one or more motivational factors associated with the one or more presented feedbacks on the one or more individuals.

At step 222, the generated motivation profiles of the one or more individuals are updated by updating the modified values of the one or more motivational factors listed in the one or more generated motivation profiles. The modified values of the one or more motivational factors are updated based on the determined degree of influence of each of the one or more motivational factors associated with the one or more presented feedbacks on the one or more individuals.

Once the motivation profiles of the one or more individuals are generated and updated, additional stimuli and feedbacks associated with other motivational factors are again presented to the one or more individuals. In an embodiment of the present invention, the additional stimuli are presented to the one or more individuals based on the generated motivation profiles of the one or more individuals and previously presented one or more stimuli and the one or more feedbacks. One or more responses associated with the additional stimuli presented to the one or more individuals are then received from the one or more individuals. The one or more responses are processed to determine if the behavior of the one or more individuals is influenced by the motivational factors associated with the additional stimuli presented to the one or more individuals. All the motivational factors that influence the behavior of the one or more individuals are thereby accurately determined. The one or more generated motivation profiles of the one or more individuals are then updated by updating the values of all the motivational factors that influence the one or more individuals based on the degree of influence of each motivational factor.

In an exemplary embodiment of the present invention, motivation profiles of the one or more individuals are generated by facilitating the one or more individuals to play games and recording interaction and performance of the one or more individuals. During operation, an individual is first prompted to play one or more games. Each of the one or more games comprises areas where one or more game elements are displayed. Further, a stimulus and a feedback are presented together in the form of the one or more game elements. In an embodiment of the present invention, the one or more game elements are in the form of, but not limited to, leaderboard, progress bar, points display, badges, levels, money, prizes, stars and smileys. When the individual plays a game, the processing module records the individual's performance to determine the individual's response to the stimulus and feedback provided via the one or more game elements. The motivation profile of the individual is then generated based on the performance in the played game. The individual is then presented with additional games comprising different game elements. The individual's interaction and performance is again recorded and processed to accurately determine additional motivational factors that motivate and influence behavior of the individual. The individual is then prompted to play more games and the generated motivation profile of the individual is continuously modified to accurately determine all the motivational factors that motivate and influence behavior of the individual.

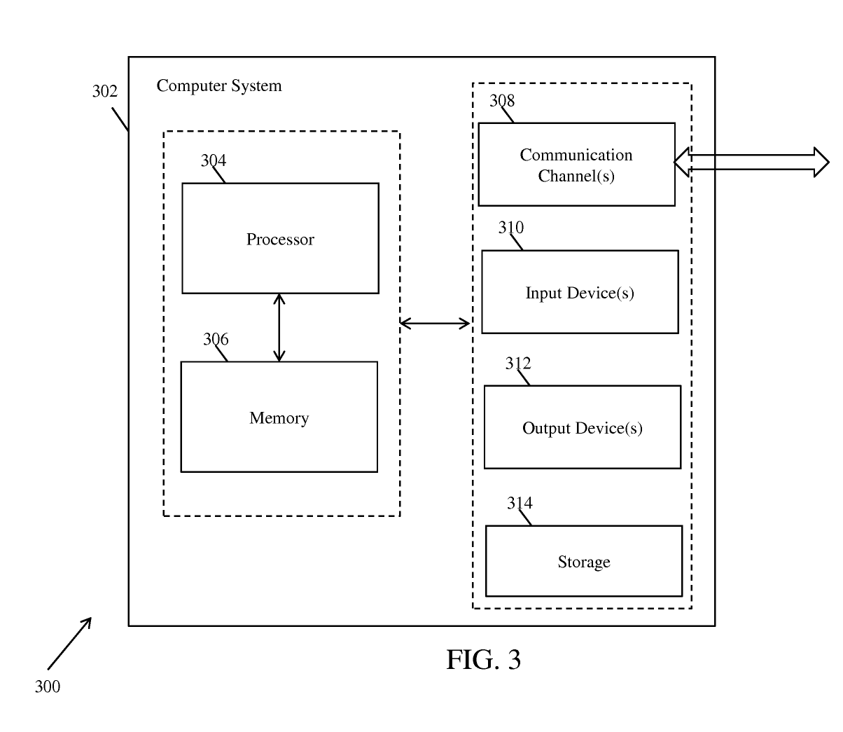

FIG. 3 illustrates an exemplary computer system for generating motivation profiles of one or more individuals, in accordance with an embodiment of the present invention.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for generating motivation profiles of one or more individuals, the system comprising:
an administrator interface configured to provide one or more options to one or more administrators to:
configure one or more default profiles, wherein configuring the one or more default profiles comprises assigning an initial value to each of one or more motivational factors listed in the one or more default profiles; and
define one or more stimuli, wherein defining the one or more stimuli comprises associating the one or more stimuli with the one or more motivational factors; and
a processing module configured to:
present the one or more defined stimuli to the one or more individuals on one or more user devices;
receive one or more responses to the one or more presented stimuli from the one or more individuals;
process the one or more received responses;
determine, using the one or more processed responses, if the one or more motivational factors associated with the one or more presented stimuli influenced the behavior of the one or more individuals and motivated the one or more individuals to perform one or more actions corresponding to the one or more presented stimuli;
determine, using the one or more processed responses, degree of influence of each of the one or more motivational factors associated with the one or more presented stimuli on the one or more individuals; and
generate motivation profiles of the one or more individuals by modifying the initial value assigned to each of the one or more motivational factors, listed in the one or more configured default profiles, based on the determined degree of influence of each of the one or more motivational factors on the one or more individuals.

2. The system of claim 1, wherein the administrator interface further provides one or more options to the one or more administrators to define one or more feedbacks and associate the one or more defined feedbacks with the one or more defined stimuli and the one or more motivational factors.

3. The system of claim 2, wherein the processing module is further configured to:
present the one or more defined feedbacks to the one or more individuals via the one or more user devices based on the one or more received responses;
receive one or more additional responses to the one or more presented feedbacks from the one or more individuals;
process the one or more additional responses;
determine, using the one or more processed additional responses, if the one or more motivational factors associated with the one or more presented feedbacks influenced the behavior of the one or more individuals and motivated the one or more individuals to further perform the one or more actions corresponding to the one or more presented stimuli;
determine, using the one or more processed additional responses, degree of influence of each of the one or more motivational factors associated with the one or more presented feedbacks on the one or more individuals; and
modify the generated motivation profiles of the one or more individuals by updating the modified value of each of the one or more motivational factors, listed in the one or more generated motivation profiles, based on the determined degree of influence of each of the one or more motivational factors associated with the one or more presented feedbacks on the one or more individuals.

4. The system of claim 3, wherein the processing module is configured to:
present one or more additional stimuli to the one or more individuals based on the modified motivation profiles of the one or more individuals, wherein the one or more additional stimuli are associated with additional motivational factors;
process one or more responses to the one or more additional stimuli; and
update the modified motivation profiles of the one or more individuals by updating values of the additional motivational factors, listed in the one or more generated motivation profiles, based on the processed one or more responses to the one or more additional stimuli.

5. The system of claim 1, wherein the initial value assigned to the one or more motivational factors listed in the one or more default profiles is a percentage and further wherein sum total of values of all motivational factors listed in the one or more default profiles is one hundred percent (100%).

6. The system of claim 1, wherein the one or more motivational factors include at least one of: competition, challenge, personal progression, social status, money, autonomy, exploration, social responsibility, charity, and affection.

7. The system of claim 1, wherein defining the one or more stimuli comprises assigning a value to each of the one or more motivational factors associated with the one or more stimuli.

8. The system of claim 1, wherein the one or more user devices include at least one of: tablets, smartphones, laptops, gaming devices and any other electronic devices.

9. The system of claim 1, wherein the processing module is configured to:
present one or more additional stimuli to the one or more individuals based on the generated motivation profiles of the one or more individuals, wherein the one or more additional stimuli are associated with additional motivational factors;
process one or more responses to the one or more additional stimuli; and
modify the generated motivation profiles of the one or more individuals by modifying value of the additional motivational factors, listed in the one or more generated motivation profiles, based on the processed one or more responses to the one or more additional stimuli.

10. The system of claim 1, wherein the one or more administrators include at least one of: Human Resource (HR) managers, resource planners, senior managers, senior executives and stakeholders of an organization.

11. A computer-implemented method for generating motivation profiles of one or more individuals, via program instructions stored in a memory and executed by a processor, the computer-implemented method comprising:
configuring one or more default profiles, wherein configuring the one or more default profiles comprises assigning an initial value to each of one or more motivational factors listed in the one or more default profiles;
defining one or more stimuli, wherein defining the one or more stimuli comprises associating the one or more stimuli with the one or more motivational factors;
presenting the one or more defined stimuli to the one or more individuals on one or more user devices;
receiving one or more responses to the one or more presented stimuli from the one or more individuals;
processing the one or more received responses;
determining, using the one or more processed responses, if the one or more motivational factors associated with the one or more presented stimuli influenced the behavior of the one or more individuals and motivated the one or more individuals to perform one or more actions corresponding to the one or more presented stimuli;
determining, using the one or more processed responses, degree of influence of each of the one or more motivational factors associated with the one or more presented stimuli on the one or more individuals; and
generating motivation profiles of the one or more individuals by modifying the initial value assigned to each of the one or more motivational factors, listed in the one or more configured default profiles, based on the determined degree of influence of each of the one or more motivational factors on the one or more individuals.

12. The computer-implemented method of claim 11 further comprises defining one or more feedbacks and associating the one or more defined feedbacks with the one or more defined stimuli and the one or more motivational factors.

13. The computer-implemented method of claim 12 further comprising:
presenting the one or more defined feedbacks to the one or more individuals via the one or more user devices based on the one or more received responses;
receiving one or more additional responses to the one or more presented feedbacks from the one or more individuals;
processing the one or more additional responses;
determining, using the one or more processed additional responses, if the one or more motivational factors associated with the one or more presented feedbacks influenced the behavior of the one or more individuals and motivated the one or more individuals to further perform the one or more actions corresponding to the one or more presented stimuli;
determining, using the one or more processed additional responses, degree of influence of each of the one or more motivational factors associated with the one or more presented feedbacks on the one or more individuals; and
modifying the generated motivation profiles of the one or more individuals by updating the modified value of each of the one or more motivational factors, listed in the one or more generated motivation profiles, based on the determined degree of influence of each of the one or more motivational factors associated with the one or more presented feedbacks on the one or more individuals.

14. The computer-implemented method of claim 13 further comprising:
presenting one or more additional stimuli to the one or more individuals based on the modified motivation profiles of the one or more individuals, wherein the one or more additional stimuli are associated with additional motivational factors;
processing one or more responses to the one or more additional stimuli; and
updating the modified motivation profiles of the one or more individuals by updating values of the additional motivational factors, listed in the one or more generated motivation profiles, based on the processed one or more responses to the one or more additional stimuli.

15. The computer-implemented method of claim 11, wherein the initial value assigned to the one or more motivational factors listed in the one or more default profiles is a percentage and further wherein sum total of values of all motivational factors listed in the one or more default profiles is one hundred percent (100%).

16. The computer-implemented method of claim 11, wherein the one or more motivational factors include at least one of: competition, challenge, personal progression, social status, money, autonomy, exploration, social responsibility, charity, and affection.

17. The computer-implemented method of claim 11, wherein defining the one or more stimuli comprises assigning a value to each of the one or more motivational factors associated with the one or more stimuli.

18. The computer-implemented method of claim 11, wherein the one or more user devices include at least one of: tablets, smartphones, laptops, gaming devices and any other electronic devices.

19. The computer-implemented method of claim 11 further comprising:
presenting one or more additional stimuli to the one or more individuals based on the generated motivation profiles of the one or more individuals, wherein the one or more additional stimuli are associated with additional motivational factors;
processing one or more responses to the one or more additional stimuli; and
modifying the generated motivation profiles of the one or more individuals by modifying value of the additional motivational factors, listed in the one or more generated motivation profiles, based on the processed one or more responses to the one or more additional stimuli.

20. A computer program product for generating motivation profiles of one or more individuals, the computer program product comprising:
a non-transitory computer-readable medium having computer-readable program code stored thereon, the computer-readable program code comprising instructions that when executed by a processor, cause the processor to:
configure one or more default profiles, wherein configuring the one or more default profiles comprises assigning an initial value to each of one or more motivational factors listed in the one or more default profiles;
define one or more stimuli, wherein defining the one or more stimuli comprises associating the one or more stimuli with the one or more motivational factors;
present the one or more defined stimuli to the one or more individuals on one or more user devices;
receive one or more responses to the one or more presented stimuli from the one or more individuals;
process the one or more received responses;
determine, using the one or more processed responses, if the one or more motivational factors associated with the one or more presented stimuli influenced the behavior of the one or more individuals and motivated the one or more individuals to perform one or more actions corresponding to the one or more presented stimuli;
determine, using the one or more processed responses, degree of influence of each of the one or more motivational factors associated with the one or more presented stimuli on the one or more individuals; and
generate motivation profiles of the one or more individuals by modifying the initial value assigned to each of the one or more motivational factors, listed in the one or more configured default profiles, based on the determined degree of influence of each of the one or more motivational factors on the one or more individuals.
